(19) United States
(12) Patent Application Publication
(10) Pub. No.: US 2025/0299073 A1
(43) Pub. Date: Sep. 25, 2025

(54) LOCAL LOW-RANK RESPONSE IMPUTATION FOR AUTOMATIC CONFIGURATION OF CONTEXTUALIZED ARTIFICIAL INTELLIGENCE

(71) Applicant: VIRGINIA TECH INTELLECTUAL PROPERTIES, INC., Blacksburg, VA (US)

(72) Inventors: Ran Jin, Blacksburg, VA (US); Xiaoyu CHEN, Louisville, KY (US)

(21) Appl. No.: 18/860,066

(22) PCT Filed: Apr. 25, 2023
(86) PCT No.: PCT/US2023/066206

§ 371 Date: Oct. 25, 2024

Related U.S. Application Data
(60) Provisional application No. 63/363,528, filed on Apr. 25, 2022.

(51) Int. Cl. G06N 5/02

(52) U.S. Cl. CPC G06N 5/027

(57) ABSTRACT

Contextual computation pipeline recommendation concepts are described. For example, a method can include obtaining an incomplete recommendation matrix that includes first performance data for different computation pipelines with respect to different contextual datasets. The incomplete recommendation matrix lacking second performance data for a defined computation pipeline with respect to a defined contextual dataset. The method can also include segmenting the incomplete recommendation matrix into local low-rank submatrices that lack the second performance data. The method can also include predicting the second performance data for at least one of the local low-rank submatrices to create a completed recommendation matrix that includes the first performance data and the second performance data. The method can also include ranking the defined computation pipeline and/or one or more of the different computation pipelines with respect to the defined contextual dataset and/or one or more of the different contextual datasets based on the completed recommendation matrix.

### CROSS-REFERENCE TO RELATED APPLICATION

This application claims the benefit of and priority to U.S. Provisional Patent Application No. 63/363,528, titled “Local Low-rank Response Imputation for Automatic Configuration of Contextualized Artificial Intelligence,” filed Apr. 25, 2022, the entire contents of which is hereby incorporated by reference herein.

### BACKGROUND

Artificial Intelligence (AI) plays an important role in data-driven decision-making tasks related to complex problems such as complex engineering and healthcare problems. To determine which AI method should be implemented for a particular task, data scientists configure and evaluate different computation pipelines that each include a certain sequence of AI method configuration options. For example, the computation pipelines can each include a different sequence of AI method options for data sourcing, feature extraction, dimension reduction, tuning criteria, and model estimation.

Data scientists also configure and evaluate different computation pipelines to determine which AI method should be implemented for a particular context in connection with, for instance, a certain domain, entity, task, or dataset. For example, data scientists can configure and evaluate different computation pipelines for different sample sizes, data distributions, data analytics objectives, requirements on performance and runtime metrics, custom designs, personalized specifications, and process settings.

### SUMMARY

The present disclosure is directed to contextual AI computation pipeline recommendation for different contexts embodied as different datasets (also referred to as “contextual datasets” or “context data”). More specifically, described herein is a local low-rank matrix imputation (Lori) framework that can be embodied or implemented as a software architecture to complete (impute) an incomplete recommendation matrix that initially lacks performance data for at least one computation pipeline with respect to one or more contextual datasets. In particular, the Lori framework can be implemented to predict such missing performance data based on similarities contained in relatively high-dimensional covariates of various computation pipelines and contextual datasets, as well as local low-rank properties of the incomplete recommendation matrix. Once predicted, the Lori framework can be further implemented to rank, recommend, or both rank and recommend one or more computation pipelines for use with a particular contextual dataset based on a completed recommendation matrix that includes the predicted performance data.

According to an example of the Lori framework described herein, a computing device can obtain an incomplete recommendation matrix that can include first performance data for different computation pipelines with respect to different contextual datasets. Additionally, the incomplete recommendation matrix can lack second performance data for a defined computation pipeline with respect to a defined contextual dataset. To determine the second performance data, the computing device can segment the incomplete recommendation matrix into multiple local low-rank submatrices. The computing device can then predict the second performance data for at least one of the local low-rank submatrices to create a completed recommendation matrix that includes the first performance data and the second performance data. The computing device can further rank at least one of the defined computation pipeline or one or more of the different computation pipelines with respect to at least one of the defined contextual dataset or one or more of the different contextual datasets based on the completed recommendation matrix. In this way, the Lori framework can be implemented to recommend the relatively best computation pipelines for use with a certain contextual dataset.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a block diagram of an example environment that can facilitate local low-rank matrix imputation for contextual computation pipeline recommendation according to at least one embodiment of the present disclosure.

FIG. 2 illustrates a block diagram of an example computing environment that can facilitate local low-rank matrix imputation for contextual computation pipeline recommendation according to at least one embodiment of the present disclosure.

FIG. 3A illustrates an example matrix segmenting process that can facilitate local low-rank matrix imputation for contextual computation pipeline recommendation according to at least one embodiment of the present disclosure.

FIG. 3B illustrates another example matrix segmenting process that can facilitate local low-rank matrix imputation for contextual computation pipeline recommendation according to at least one embodiment of the present disclosure.

FIG. 4 illustrates a representation of an example modified principal Hessian directions process that can facilitate local low-rank matrix imputation for contextual computation pipeline recommendation according to at least one embodiment of the present disclosure.

FIG. 5 illustrates a flow diagram of an example computer-implemented method that can facilitate local low-rank matrix imputation for contextual computation pipeline recommendation according to at least one embodiment of the present disclosure.

### DETAILED DESCRIPTION

Data scientists configure and evaluate different computation pipelines to determine which AI method should be implemented for a particular context in connection with, for instance, a certain domain, entity, task, or dataset. Currently, data scientists manually configure each of the different computation pipelines in a trial-and-error manner for each specific context. Such configuration involves determining the different options of the computation pipeline components, tuning the hyperparameters, and evaluating the advantages and limitations of each computation pipeline with respect to each context. However, manually configuring and evaluating each computation pipeline with respect to each context involves a significant amount of time and costs.

Existing computation pipeline recommendation systems provide at least some degree of automation in connection with configuring and evaluating different computation pipelines for recommendation with respect to different contexts. However, a problem with such existing systems is that they are not able to model the similarities and dissimilarities of different computation pipelines and different contexts in an effective and efficient manner. For example, such existing systems are not able to accurately quantify the similarities between different computation pipelines or the similarities between different contexts in an effective and efficient manner. As such, the computation pipeline recommendations generated by such systems are often inaccurate and not useful. Another problem with existing computation pipeline recommendation systems is that they are not scalable to allow for the evaluation of 10s, 100s, or 1000s of computation pipelines and/or contexts.

A problem with large-scale implementation of computation pipeline recommendation systems in general is that the model parameters will grow exponentially when there are relatively large numbers of different computation pipelines and/or different contexts to evaluate. As such, a substantial amount of time and computational costs are involved with recommending computation pipelines for different contexts in such a large-scale implementation scenario. Another problem with large-scale implementation of computation pipeline recommendation systems in general is that a local low-rank property of a recommendation matrix generated by any of these systems is not maintained in the large-scale implementation of such systems. The local low-rank property is an attribute shared by a subset of the computation pipelines and a corresponding subset of the contexts.

The present disclosure provides solutions to address the above-described problems associated with effective and efficient large-scale implementation of computation pipeline recommendation systems in general and with respect to the approaches used by existing technologies. For example, rather than making computation pipeline recommendations based on an entire recommendation matrix, the local low-rank matrix imputation (Lori) framework of the present disclosure can be implemented to make such recommendations based on segmented local low-rank submatrices of the recommendation matrix. The local low-rank submatrices can include one or more computation pipelines that can be recommended for use with respect to one or more particular contexts that share the same or similar attributes such as, for instance, at least one of sample size, distribution, or another attribute. Additionally, the Lori framework is scalable and adaptable to a variety of domains and contexts. For instance, the Lori framework can accommodate high-dimensional recommendation matrices having a large number of candidate computation pipelines, contexts, covariates, or some combination thereof.

Further, the Lori framework can be implemented to predict performance data missing in such relatively high-dimensional recommendation matrices by using a multivariate segmenting process in a reduced dimensional space (r.d.s.) expanded by relatively robust principal Hessian directions (pHds). The pHds can be defined based on the relatively high-dimensional covariates of the candidate computation pipelines and contexts, as well as the local low-rank properties of the recommendation matrix. In this way, the Lori framework can leverage the subtle, implicit, and often overlooked data of the relatively high-dimensional covariates while maintaining the local low-rank properties of the recommendation matrix.

The Lori framework of the present disclosure provides several technical benefits and advantages. For example, the Lori framework can provide computation pipeline recommendations based on local low-rank submatrices that have been segmented from a recommendation matrix using pHds that have been defined based on relatively high-dimensional covariates. As such, the Lori framework can allow for more accurate predictions for missing performance data because such predictions are based on relatively more accurate representations of the similarities and dissimilarities across different computation pipelines and contexts. The Lori framework can thus provide computation pipeline recommendations and rankings that are relatively more accurate because they are based on such relatively more accurate representations of the similarities and dissimilarities across the different computation pipelines and contexts. Consequently, the Lori framework can reduce the time and costs (e.g., labor costs, computational costs), as well as improve recommendation accuracy and efficiency, associated with recommending computation pipelines and for use with particular contexts.

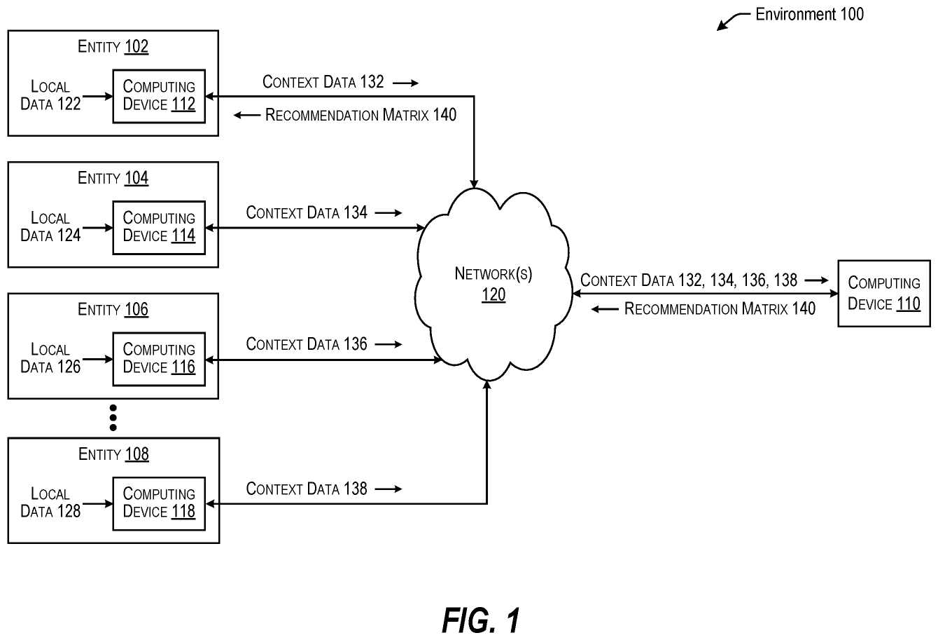

FIG. 1 illustrates a block diagram of an example environment 100 that can facilitate local low-rank matrix imputation for contextual computation pipeline recommendation according to at least one embodiment of the present disclosure. In the example illustrated in FIG. 1, the environment 100 can be a data-driven decision-making environment such as, for instance, at least one of a cyber manufacturing system (CMS), an Industrial Internet environment, an Internet of Things (IoT) environment, an Industrial Internet of Things (IIoT) environment, or another data-driven decision-making environment. However, the Lori framework of the present disclosure is not limited to such environments or any particular types of datasets.

As illustrated in FIG. 1, the environment 100 includes multiple entities, including entities 102, 104, 106, 108 that can operate independently from one another or together in a collective manner. Although FIG. 1 depicts four entities, the Lori framework of the present disclosure is not limited to use with any particular number. For instance, in some cases, the environment 100 can include as few as one entity or any number of entities greater than one.

In the example illustrated in FIG. 1, each of the entities 102, 104, 106, 108 can be embodied as, for instance, an enterprise, an organization, a company, another type of entity, or any combination thereof. For example, each of the entities 102, 104, 106, 108 can be an enterprise such as, for instance, a manufacturing enterprise, another type of enterprise, or any combination thereof.

Further, each of the entities 102, 104, 106, 108 can operate one or more types of machines, instruments, or equipment, perform one or more types of processes, use one or more types of materials or recipes, produce one or more types of products, provide one or more types of services, or any combination thereof. The entities 102, 104, 106, 108 can be heterogeneous or homogeneous with respect to one another. For instance, one or more of the operations, machines, instruments, equipment, processes, materials, recipes, products, services, and the like, of any of the entities 102, 104, 106, 108 can be the same as, similar to, or different from that of any of the other entities 102, 104, 106, 108.

Additionally, each of the entities 102, 104, 106, 108 can individually perform data-driven decision-making tasks as part of the operations undertaken by the entities. The data-driven decision-making tasks can be associated with or specific to a particular context. For instance, such data-driven decision-making tasks can be associated with or specific to a particular context related to their respective operations, machines, instruments, equipment, processes, materials, recipes, products, services, and the like. To perform the data-driven decision-making tasks, any or all of the entities 102, 104, 106, 108 can individually implement one or more AI models and/or methods. Use of the AI models can improve the data-driven decision-making tasks or the outcomes of those tasks in many cases, saving time, costs, and leading to other benefits.

The entities 102, 104, 106, 108 can each include or be coupled to a computing device 112, 114, 116, 118. Each of the computing devices 112, 114, 116, 118 can be embodied or implemented as, for instance, a server, a client computing device, a peripheral computing device, or both. Examples of each of the computing devices 112, 114, 116, 118 can include a computer, a general-purpose computer, a special-purpose computer, a server, a laptop, a tablet, a smartphone, another client computing device, or any combination thereof. The entities 102, 104, 106, 108 can each user their own computing device 112, 114, 116, 118 to perform one or more aspects of the Lori framework described herein.

As illustrated in FIG. 1, each of the computing devices 112, 114, 116, 118 can be communicatively coupled, operatively coupled, or both to a computing device 110 by way of one or more networks 120 (hereinafter, “the networks 120”). The computing device 110 can implement one or more aspects of the Lori framework described herein. The computing device 110 can be embodied or implemented as, for instance, a server computing device, a virtual machine, a supercomputer, a quantum computer or processor, another type of computing device, or any combination thereof. In one example, the computing device 110 can be associated with a data center, physically located at such a data center, or both.

The networks 120 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The entities 102, 104, 106, 108 can use their respective computing device 112, 114, 116, 118 to communicate data with one another and with the computing device 110 over the networks 120 using any suitable systems interconnect models and/or protocols. Example interconnect models and protocols include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the networks 120, without limitation. Although not illustrated, the networks 120 can also include connections to any number of other network hosts, such as website servers, file servers, networked computing resources, databases, data stores, or other network or computing architectures in some cases.

Although not illustrated in FIG. 1 for clarity purposes, the entities 102, 104, 106, 108 can each include or be coupled (e.g., communicatively, operatively) to one or more data collection devices that can measure or capture local data 122, 124, 126, 128 that can be respectively associated with the entities 102, 104, 106, 108. Examples of such data collection devices can include, but are not limited to, one or more sensors, actuators, instruments, manufacturing tools, programmable logic controllers (PLCs), Internet of Things (IoT) devices, Industrial Internet of Things (IIoT) devices, or any combination thereof. Additionally, each of the computing devices 112, 114, 116, 118 can be coupled (e.g., communicatively, operatively) to the data collection devices of the respective entities 102, 104, 106, 108. In this way, the computing devices 112, 114, 116, 118 can respectively receive the local data 122, 124, 126, 128 of the respective entities 102, 104, 106, 108 as illustrated in FIG. 1.

The local data 122, 124, 126, 128 can correspond to, be associated with, and be owned by the entities 102, 104, 106, 108, respectively. Among other types of data, the local data 122, 124, 126, 128 can include sensor data, annotated sensor data, another type of local data, or any combination thereof. The sensor data can be respectively captured or measured locally by any of the entities 102, 104, 106, 108. The annotated sensor data can include sensor data that has been respectively captured or measured locally by any of the entities 102, 104, 106, 108 and further annotated, respectively, by the entities 102, 104, 106, 108 that locally captured or measured such sensor data. The sensor data, the annotated sensor data, or both can be stored locally by any of the entities 102, 104, 106, 108, respectively, that captured or measured the sensor data or created the annotated sensor data.

In some cases, the local data 122, 124, 126, 128 can include or be indicative of multivariate data such as, for instance, multivariate time series (MTS) data. In some examples, the local data 122, 124, 126, 128 can include or be indicative of one or more contexts. For instance, the local data 122, 124, 126, 128 can include or be indicative of one or more contexts related to the respective operations, machines, instruments, equipment, processes, materials, recipes, products, services, and the like of the entities 102, 104, 106, 108. Example contexts for each of the local data 122, 124, 126, 128 can include, but are not limited to, sample sizes, data distributions, data analytics objectives, requirements on performance and runtime metrics, custom designs, personalized specifications, process settings, another context, or any combination thereof.

The local data 122, 124, 126, 128 can be respectively used by the entities 102, 104, 106, 108 to individually perform data-driven decision-making tasks in connection with their respective operations, machines, instruments, equipment, processes, materials, recipes, products, services, and the like. In some cases, the local data 122, 124, 126, 128 can be respectively generated by the entities 102, 104, 106, 108 as a result of performing data-driven decision-making tasks in connection with their respective operations, machines, instruments, equipment, processes, materials, recipes, products, services, and the like. In one example, the local data 122, 124, 126, 128 can be respectively used by the entities 102, 104, 106, 108 to individually train, implement, and/or evaluate at least one of a machine learning (ML) model, an AI model, or another model that can perform data-driven decision-making tasks with respect to a certain context.

To augment the individual performance of data-driven decision-making tasks by any of the entities 102, 104, 106, 108 with respect to one or more different contexts, such entities can share their respective data with one another and with the computing device 110 using the networks 120. For example, the entities 102, 104, 106, 108 can share their respective local data 122, 124, 126, 128 in the form of contextual datasets 132, 134, 136, 138 (also referred to herein and denoted in FIG. 1 as “context data 132, 134, 136, 138”). Each of the context data 132, 134, 136, 138 can include or be indicative of a certain context that can be represented in the form of one or more datasets. Similar to the local data 122, 124, 126, 128, example contexts for each of the context data 132, 134, 136, 138 can include, but are not limited to, sample sizes, data distributions, data analytics objectives, requirements on performance and runtime metrics, custom designs, personalized specifications, process settings, or any combination thereof. In one example, each of the context data 132, 134, 136, 138 can include or be indicative of a certain manufacturing context.

Although only four contextual datasets are depicted in FIG. 1 (i.e., the context data 132, 134, 136, 138), the Lori framework described herein is not limited to operations with any number of contextual datasets. In particular, the environment 100 can facilitate local low-rank matrix imputation for contextual computation pipeline recommendation based on a number of contexts or contextual datasets that is greater than four in some cases or less than four in other cases. For instance, in some cases, any or all of the entities 102, 104, 106, 108 can share one or more additional contextual datasets with one another and the computing device 110. Such one or more additional contextual datasets can include or be indicative of one or more contexts that are different from one another and different from the contexts of the context data 132, 134, 136, 138.

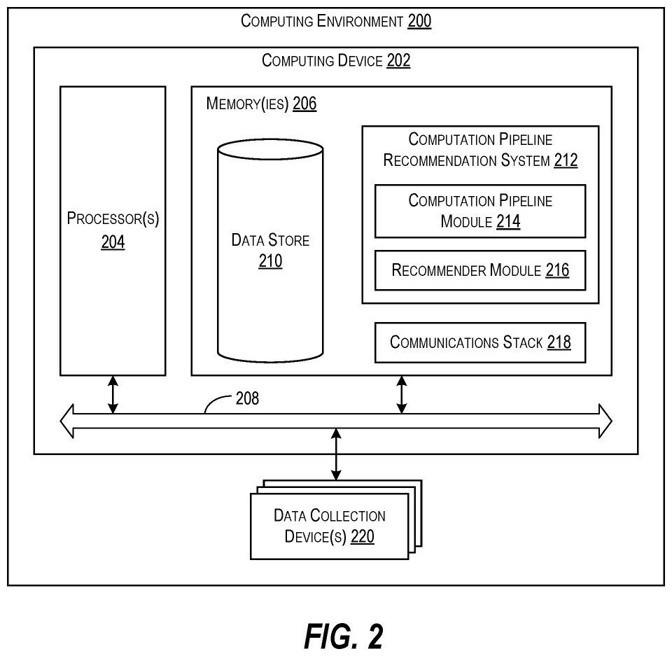

The context data 132, 134, 136, 138 can be used to train, implement, and/or evaluate, for instance, an AI model that can perform data-driven decision-making tasks with respect to a particular context. In one example, the computing device 110 and the computing devices 112, 114, 116, 118 can use any of the context data 132, 134, 136, 138 to individually train, implement, and/or evaluate an AI model or models that can perform data-driven decision-making tasks with respect to a certain context. Among all the AI models available, certain AI models may be better suited for data-driven decision-making tasks and outcomes with respect to a certain context based on a range of factors. To determine which AI model or models should be used (e.g., are best suited for certain outcomes or criteria) for a certain context, any or all of the computing devices 110, 112, 114, 116, 118 can employ a computation pipeline recommendation system. In one example, the computing devices 110, 112, 114, 116, 118 can employ the computation pipeline recommendation system 212 described below and illustrated in FIG. 2 to determine which AI model or models should be used for a certain context before training and testing of the AI model or models.

In some cases, any or all of the computing devices 112, 114, 116, 118 can respectively include and implement a computation pipeline recommendation system, as described herein, to identify the relatively best AI model or models for use with a certain context in view of certain factors or criteria. For instance, the computing devices 112, 114, 116, 118 can individually implement a computation pipeline recommendation system to identify the best AI models for use with one or more of the context data 132, 134, 136, 138, another context or contextual dataset, or any combination thereof.

In other cases, the computing device 110 can include and implement the computation pipeline recommendation system as a service to identify the best AI models for use by any or all of the computing devices 112, 114, 116, 118 with respect to a certain context. For instance, the computing device 110 can implement the computation pipeline recommendation system as a service to identify the AI models to be used by any or all of the computing devices 112, 114, 116, 118 for one or more of the context data 132, 134, 136, 138, another context or contextual dataset, or any combination thereof.

The computation pipeline recommendation system can include a computation pipeline module and a recommender module, among other functional components. In one example, the computation pipeline recommendation system can include the computation pipeline module 214 and the recommender module 216 described below and illustrated in FIG. 2. The computation pipeline module can be configured to generate different computation pipelines that are each indicative of and correspond to a unique AI model. Each computation pipeline, and thus each corresponding unique AI model, is defined as a unique sequence of different AI method options that can be implemented sequentially to perform different AI operations. The recommender module can be configured to evaluate different computation pipelines with respect to the different contexts of the context data 132, 134, 136, 138 and identify the computation pipelines for use with at least one of the context data 132, 134, 136, 138. The identified or selected computation pipelines can be those that meet certain requirements or criteria, lead to certain decisions or outcomes, or fit other requirements.

The recommender module can provide computation pipeline recommendations in the form of, for example, a recommendation matrix 140 (also referred to as a “response matrix”). The recommendation matrix 140 can include data representative of different computation pipelines that have been evaluated by the recommender module with respect to different contexts of the context data 132, 134, 136, 138, as examples, among other contextual datasets. Additionally, the recommendation matrix 140 can include a ranking of the different computation pipelines. For instance, the recommender module can generate the recommendation matrix 140 such that it includes a ranking value for each computation pipeline with respect to each of the context data 132, 134, 136, 138. The recommender module can assign the ranking values based on performance data corresponding to each computation pipeline for each of the context data 132, 134, 136, 138. The performance data can be indicative of the respective performance accuracy of each computation pipeline with respect to each of the context data 132, 134, 136, 138. For example, the performance data can be indicative of how accurately or inaccurately each respective computation pipeline performs compared to the other computation pipelines with respect to each of the context data 132, 134, 136, 138.

In some cases, the recommender module can obtain performance data by individually implementing each computation pipeline using one of the context data 132, 134, 136, 138 for each implementation. In these cases, the performance data can be indicative of observed or empirical performance data. In other cases, the recommender module can predict at least a portion of the performance data. For instance, in some cases, the recommendation matrix 140 may initially lack at least some observed or previously predicted performance data for one or more particular computation pipelines with respect to one or more of the context data 132, 134, 136, 138. In these cases, the recommender module can implement the Lori framework to predict performance data initially missing in the recommendation matrix 140. Based on predicting such performance data, the recommender module can then recommend and/or rank one or more particular computation pipelines for use with to one or more of the context data 132, 134, 136, 138, among other context data.

Where the computing device 110 implements the computation pipeline recommendation system as a service, one or more of the computing devices 112, 114, 116, 118 can send the computing device 110 a request for a recommendation of one or more AI models that are relatively best suited for use with a particular, defined context. In one example, the computing device 112 can send the computing device 110 a request for a ranking of the computation pipelines for use with a defined context or contextual dataset such as, for instance, the context data 132. Based on receiving such a recommendation request, the computing device 110 can implement the computation pipeline recommendation system using the context data 132, 134, 136, 138, and additional context data in some cases, to generate the recommendation matrix 140. The recommendation matrix 140 can include a recommendation or a ranking of the computation pipelines for use with the context data 132. The computing device 110 can also communicate the recommendation matrix 140 back to the computing device 112 in response to the request.

However, the computation pipeline recommendation system may encounter new data in some cases. For example, one or more of the context data 132, 134, 136, 138 can include new context data that has not been previously used by the computation pipeline recommendation system to evaluate computation pipelines. Therefore, the computation pipeline recommendation system may not have performance data for any computation pipeline with respect to such new context data. Also, in some cases, when evaluating different computation pipelines, the computation pipeline recommendation system can evaluate a new computation pipeline that has not been previously evaluated with respect to at least one of the context data 132, 134, 136, 138 or another contextual dataset. Thus, the computation pipeline recommendation system may not have performance data for the new computation pipeline. Consequently, the recommendation matrix 140 can be an incomplete recommendation matrix 140 in some cases. Such an incomplete recommendation matrix 140 can include performance data for certain computation pipeline and contextual dataset combinations but lack performance data for other computation pipeline and contextual dataset combinations. In any case, as noted above, the performance data in an incomplete recommendation matrix 140 can include observed or empirical performance data, predicted performance data, or a combination thereof with respect to a range of computation pipeline and contextual dataset combinations, although some performance data is lacking.

As noted above, the recommender module of the computation pipeline recommendation system can be configured to predict performance data for one or more computation pipelines with respect to one or more contexts. In one example, based on receiving the above-described recommendation request from the computing device 112, the computing device 110 can implement the recommender module to predict any or all missing performance data for one or more computation pipelines with respect to at least one of the context data 132, 134, 136, 138 or other contextual datasets. The recommender module can then use the predicted performance data to populate one or more empty or missing elements (i.e., empty cells) in an incomplete recommendation matrix 140, to create a completed recommendation matrix 140. Additionally, the computing device 110 can create the completed recommendation matrix 140 such that it also includes at least one of a recommendation or a ranking of one or more particular computation pipelines for use with respect to at least one of the context data 132, 134, 136, 138 or other contextual datasets.

To predict such missing performance data, the computing device 110 can segment the above-described incomplete recommendation matrix 140 into multiple local low-rank submatrices. Any or all of the local low-rank submatrices can lack performance data for one or more computation pipelines with respect to contextual datasets. The computing device 110 (e.g., via the recommender module) can segment the incomplete recommendation matrix 140 into multiple local low-rank submatrices based on one or more similarities between different computation pipelines and different contextual datasets used to evaluate such computation pipelines, as well as one or more local low-rank properties of the incomplete recommendation matrix 140. Each local low-rank property can be an attribute shared by a subset of the different computation pipelines and a corresponding subset of the different contextual datasets used to evaluate the subset of the different computation pipelines.

More specifically, the computing device 110 (e.g., via the recommender module) can segment the incomplete recommendation matrix 140 into multiple local low-rank submatrices based on local low-rank properties of the incomplete recommendation matrix 140 and one or more similarities between covariates of different computation pipelines and different contextual datasets used to evaluate such computation pipelines. For instance, the computing device 110 can segment the incomplete recommendation matrix 140 into multiple local low-rank submatrices based on local low-rank properties of the incomplete recommendation matrix 140 and one or more similarities between covariates of different computation pipelines and at least one of the context data 132, 134, 136, 138 or contextual datasets.

To segment the incomplete recommendation matrix 140 based on local low-rank properties of the incomplete recommendation matrix 140 and similarities between such covariates described above, the computing device 110 (e.g., via the recommender module) can perform a modified, relatively robust principal Hessian directions (pHd) process (hereinafter, “the robust pHd process”) to estimate one or more relatively robust principal Hessian directions (hereinafter, “the robust pHds”). The robust pHds can be associated with and correspond to the above-described covariates, local low-rank properties of the incomplete recommendation matrix, and/or the local low-rank submatrices. In particular, the robust pHds can be used to segment the incomplete recommendation matrix 140 into the local low-rank submatrices based on covariates of different computation pipelines and at least one of the context data 132, 134, 136, 138 or other contextual datasets, as well as local low-rank properties of the incomplete recommendation matrix 140. Each local low-rank property can be an attribute shared by a subset of the different computation pipelines and at least one of the context data 132, 134, 136, 138 or another contextual dataset used to evaluate the subset of the different computation pipelines.

The robust pHd process described herein in connection with the Lori framework provides advantages unrealized by existing matrix completion systems. Specifically, when implemented to estimate the robust pHds, the robust pHd process can reduce the impact of Gaussian noise such that neither the robust pHd process nor the robust pHds are affected by such noise. Additionally, when implemented to estimate the robust pHds, the robust pHd process can provide an estimated performance value or values for performance data missing in the incomplete recommendation matrix 140. In this way, the robust pHd process can be implemented such that neither the robust pHd process nor the robust pHds are affected by the performance data lacking in the incomplete recommendation matrix 140 and lacking in one or more of the local low-rank submatrices.

After estimating the robust pHds, the computing device 110 can then implement a tree model in some cases to segment the incomplete recommendation matrix 140 into the local low-rank submatrices based on the robust pHds. In one example, the computing device 110 can implement a tree model such as, for instance, a linear regression tree model to segment the incomplete recommendation matrix 140 into the local low-rank submatrices based on the robust pHds. The computing device 110 can implement the tree model in an effective dimension reduction (e.d.r.) space that can be expanded by the robust pHds, and thus, can be an expanded e.d.r. space.

In one example, the computing device 110 can implement the tree model in the expanded e.d.r. space to segment the incomplete recommendation matrix 140 along one or more of the robust pHds. For instance, the computing device 110 can implement the tree model in the expanded e.d.r. space to segment a residual surface of a linear regression representation along one or more of the robust pHds. The residual surface, the linear regression representation, or both can be shown in a graphical representation defined in the expanded e.d.r. space. In one example, the residual surface, the linear regression representation, or both can be defined based on at least some of the performance data included in the incomplete recommendation matrix 140 and at least some covariates of different computation pipelines and the context data 132, 134, 136, 138, among other contextual datasets.

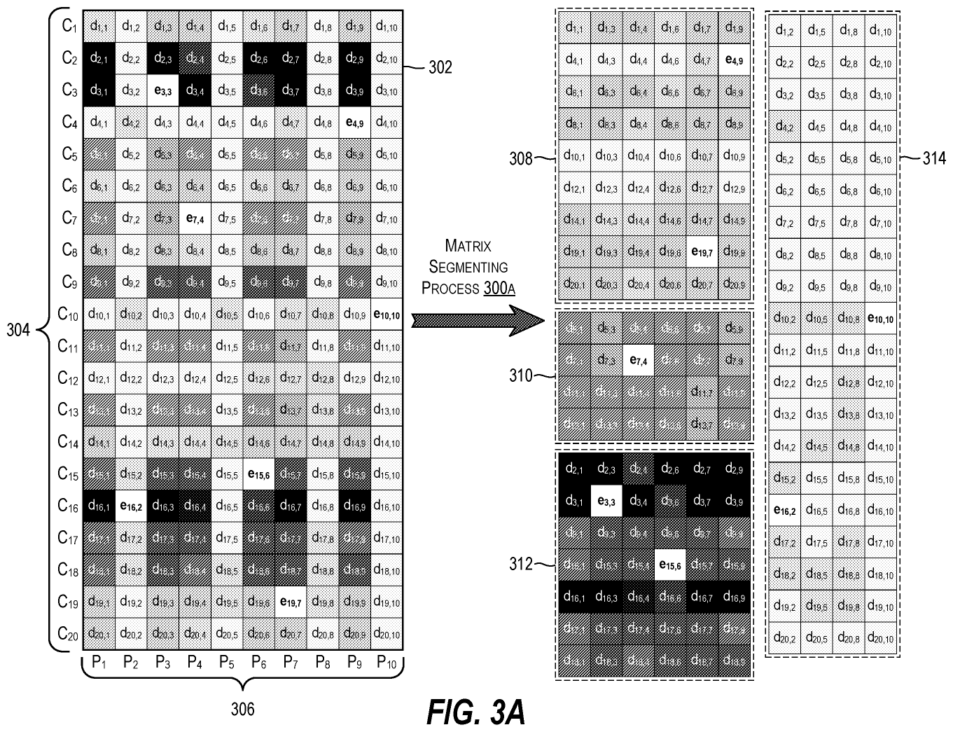

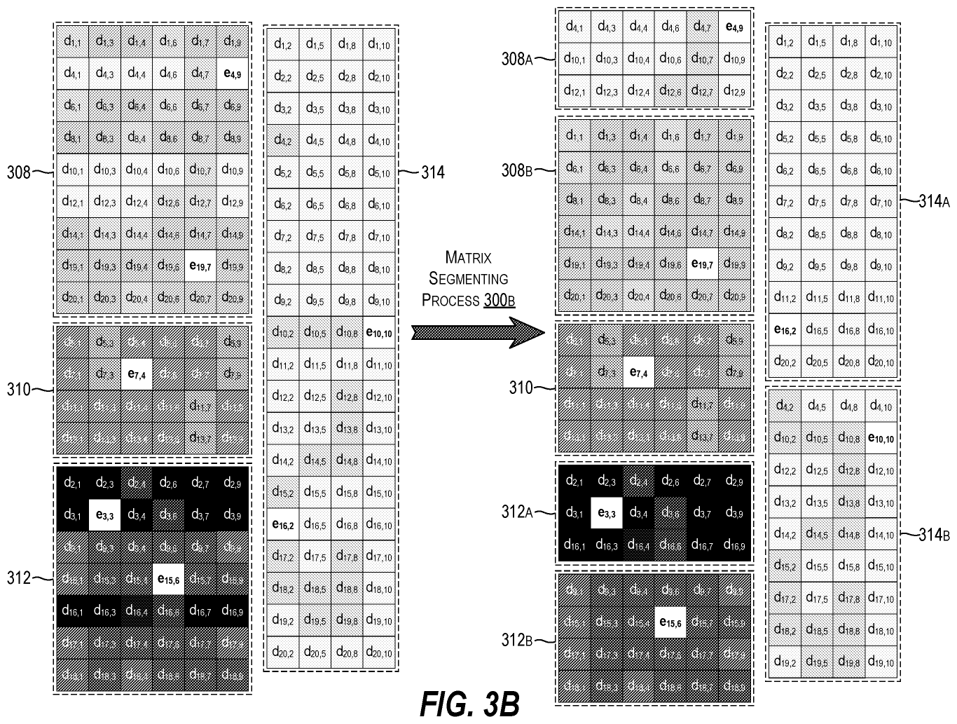

The computing device 110 can implement the tree model to recursively segment the incomplete recommendation matrix 140 into the local low-rank submatrices, as also described below with reference to FIGS. 3A and 3B. The computing device 110 can implement the tree model to recursively segment the incomplete recommendation matrix 140 along one or more of the robust pHds by growing the tree model in the expanded e.d.r. space. In one example, the computing device 110 can implement the tree model to recursively segment the incomplete recommendation matrix 140 along one or more of the robust pHds by growing one or more treed extended matrix completion models in the expanded e.d.r. space. As described below, each of the treed extended matrix completion models can be defined and trained during, and by way of, the segmentation of the incomplete recommendation matrix 140. In some cases, the computing device 110 can implement the tree model to grow one or more treed extended matrix completion models in the expanded e.d.r. space based on performance data included in the incomplete recommendation matrix 140 and covariates of different computation pipelines, the context data 132, 134, 136, 138, and other contextual datasets. In this way, the computing device 110 (e.g., via the tree model) can recursively segment the incomplete recommendation matrix 140 along one or more of the robust pHds until all of the local low-rank submatrices are defined.

When segmenting the incomplete recommendation matrix 140 into the local low-rank submatrices, the computing device 110 (e.g., via the recommender module) can learn certain information that can be used to predict the missing performance data in the incomplete recommendation matrix 140. The computing device 110 can learn certain information associated with local low-rank properties of the incomplete recommendation matrix 140, one or more computation pipelines, at least one of the context data 132, 134, 136, 138 or other contextual datasets, and/or any or all performance data included in the incomplete recommendation matrix 140.

In one example, when segmenting the incomplete recommendation matrix 140 as described above, the computing device 110 can learn one or more relationships between one or more computation pipelines, the context data 132, 134, 136, 138 and/or other contextual datasets, and any or all performance data included in the incomplete recommendation matrix 140. More specifically, the computing device 110 can learn one or more relationships between such performance data and covariates of the one or more computation pipelines. Further, the computing device 110 can learn one or more relationships between such performance data and any or all of the contextual datasets. The computing device 110 can also learn one or more relationships between the covariates of the one or more computation pipelines and the covariates of any or all of the contextual datasets.

In another example, when segmenting the incomplete recommendation matrix 140 as described above, the computing device 110 can learn one or more similarities between one or more computation pipelines and any or all of the context data 132, 134, 136, 138 or another contextual dataset. More specifically, the computing device 110 can learn one or more similarities between covariates of the one or more computation pipelines and covariates of any or all of the context data 132, 134, 136, 138 or another contextual dataset.

Additionally, when segmenting the incomplete recommendation matrix 140, the computing device 110 can learn one or more similarities between one or more computation pipelines and a defined computation pipeline (e.g., a new computation pipeline) with respect to any or all of the contextual datasets available. The computing device 110 can learn one or more similarities between covariates of the one or more computation pipelines, covariates of the defined computation pipeline, and covariates of any or all of the contextual datasets.

In another example, when segmenting the incomplete recommendation matrix 140, the computing device 110 can learn one or more similarities between the contextual datasets and a defined contextual dataset (e.g., a new contextual dataset) with respect to one or more computation pipelines. More specifically, the computing device 110 can learn one or more similarities between covariates of the context data 132, 134, 136, 138 or other contextual datasets, covariates of the defined contextual dataset, and covariates of the one or more computation pipelines.

Based on learning the above-described local low-rank properties, relationships, and similarities when segmenting the incomplete recommendation matrix 140 into the local low-rank submatrices, the computing device 110 can then use such learned information to predict the missing performance data in the incomplete recommendation matrix 140. The computing device 110 can use such learned information to predict the missing performance data in the incomplete recommendation matrix 140 by predicting the missing performance data in each of the local low-rank submatrices. In particular, the computing device 110 can use such learned information to predict a performance value for each empty element or cell in each of the local low-rank submatrices that lack performance data. In this way, the computing device 110 can complete the incomplete recommendation matrix 140 to create a completed recommendation matrix 140.

To predict the missing performance data in each of the local low-rank submatrices based on the above-described local low-rank properties, relationships, and similarities learned from segmenting the incomplete recommendation matrix 140, the computing device 110 can implement one or more treed extended matrix completion models. In one example, each treed extended matrix completion model can include or be indicative of an extended matrix completion model combined with a tree-based model. For instance, in some cases, each treed extended matrix completion model can include or be indicative of an extended matrix completion model combined with a linear regression tree model. Each treed extended matrix completion model can be associated with, correspond to, and be trained to predict performance data missing in one of the local low-rank submatrices.

The computing device 110 can define and/or train one or more treed extended matrix completion models to respectively predict the missing performance data in the local low-rank submatrices based on segmenting the incomplete recommendation matrix 140 into the local low-rank submatrices. For instance, based on using a tree model (e.g., a linear regression tree model in some cases) to segment the incomplete recommendation matrix 140 into the local low-rank submatrices and learning the above-described local low-rank properties, relationships, and similarities by way of completing such a segmenting process, the computing device 110 can cause the tree model to effectively transform into one or more treed extended matrix completion models. In this example, upon completing such a segmenting process, each treed extended matrix completion model can thereafter be associated with, correspond to, and be trained to predict performance data missing in one of the local low-rank submatrices.

Once the computing device 110 has segmented the incomplete recommendation matrix 140 into the local low-rank submatrices, thereby causing the development and training of one or more treed extended matrix completion models as described above, the computing device 110 can then implement any or all of such models to respectively predict the missing performance data in any or all of the local low-rank submatrices. In one example, each treed extended matrix completion model can predict such missing performance data based on the above-described local low-rank properties, relationships, and similarities that can be learned when the incomplete recommendation matrix 140 is segmented into the local low-rank submatrices. For instance, in some cases, each treed extended matrix completion model can predict such missing performance data based on one or more similarities between covariates of any or all of the context data 132, 134, 136, 138 or another contextual dataset and covariates of at least one computation pipeline.

For a certain local low-rank submatrix that lacks performance data for a first computation pipeline with respect to a certain contextual dataset (e.g., any or all of the context data 132, 134, 136, 138 or other contextual datasets), one of the above-described treed extended matrix completion models can identify a second computation pipeline in the same local low-rank submatrix that has covariates that are similar to covariates of the first computation pipeline with respect to the same contextual dataset. Based on identifying the second computation pipeline, the treed extended matrix completion model can use the performance data of the second computation pipeline to predict the missing performance data for the first computation pipeline. In one example, the treed extended matrix completion model can use the performance data of the second computation pipeline as the performance data for the first computation pipeline. In another example, the treed extended matrix completion model can use performance data for the first computation pipeline that is similar to the performance data of the second computation pipeline based on a degree of similarity between their respective covariates.

Once all treed extended matrix completion models have populated all empty elements or cells in all of the local low-rank submatrices with predicted performance data, the computing device 110 can thereby create a completed recommendation matrix 140. The completed recommendation matrix 140 can therefore include empirical or predicted performance data for all computation pipelines with respect to all the context data 132, 134, 136, 138, among other contextual datasets. In some cases, the completed recommendation matrix 140 can include empirical or predicted performance data, as well as a predicted ranking for all computation pipelines with respect to all the context data 132, 134, 136, 138, among other contextual datasets.

The computing device 110 can also rank the computation pipelines, or a subset thereof, in the completed recommendation matrix 140 with respect to the contextual datasets based on their respective empirical or predicted performance data. For instance, the computing device 110 can rank the computation pipelines, or a subset thereof, that are included in the completed recommendation matrix 140 with respect to the context data 132 based on their respective empirical or predicted performance data. The ranking can be performed with respect to other contextual datasets as well.

In some cases, the computing device 110 can also generate a recommendation of one or more computation pipelines in the completed recommendation matrix 140 that are relatively best suited for a particular contextual dataset based on ranking such one or more computation pipelines with respect to such a contextual dataset. For instance, the computing device 110 can generate a recommendation of one or more computation pipelines in the completed recommendation matrix 140 that are relatively best suited for the context data 132 based on ranking such one or more computation pipelines with respect to the context data 132. The computing device 110 can further use the networks 120 to provide the computing device 112 with at least one of the completed recommendation matrix 140, the above-described computation pipeline ranking, or the above-described computation pipeline recommendation in response to the recommendation request from the computing device 112. These and other aspects of the embodiments are described in further detail below with reference to FIGS. 2, 3A, 3B, 4, and 5.

FIG. 2 illustrates a block diagram of an example computing environment 200 that can facilitate local low-rank matrix imputation for contextual computation pipeline recommendation. The computing environment 200 can include or be coupled (e.g., communicatively, operatively) to a computing device 202.

With reference to FIGS. 1 and 2 collectively, the computing environment 200 can be used, at least in part, to embody or implement any of the entities 102, 104, 106, 108. The computing device 202 can be used, at least in part, to embody or implement any of the computing devices 110, 112, 114, 116, 118. In an example where the computing device 110 can be associated with a data center, physically located at such a data center, or both, the computing environment 200 can be used, at least in part, to embody or implement the data center.

The computing device 202 can include at least one processing system, for example, having at least one processor 204 and at least one memory 206, both of which can be communicatively coupled, operatively coupled, or both, to a local interface 208. The memory 206 includes a data store 210, a computation pipeline recommendation system 212, a computation pipeline module 214, a recommender module 216, and a communications stack 218 in the example shown. The computing device 202 can also be communicatively coupled, operatively coupled, or both, by way of the local interface 208 to one or more data collection devices 220 (hereinafter, “the data collection devices 220”) of the computing environment 200. The computing environment 200 and the computing device 202 can also include other components that are not illustrated in FIG. 2.

In some cases, the computing environment 200, the computing device 202, or both may or may not include all the components illustrated in FIG. 2. For example, in some cases, depending on how the computing environment 200 is embodied or implemented, the computing environment 200 may or may not include the data collection devices 220, and thus, the computing device 202 may or may not be coupled to the data collection devices 220. Also, in some cases, depending on how the computing device 202 is embodied or implemented, the memory 206 may or may not include the computation pipeline recommendation system 212, the computation pipeline module 214, the recommender module 216, the communications stack 218, any combination thereof, or other components. For instance, in an embodiment where any or all of the computing devices 112, 114, 116, 118 offload their entire Lori-based contextual computation pipeline recommendation processing workload to the computing device 110, any or all of such devices may not include at least one of the computation pipeline recommendation system 212, the computation pipeline module 214, or the recommender module 216.

The processor 204 can include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 204 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 206 can be embodied as one or more memory devices and store data and software or executable-code components executable by the processor 204. For example, the memory 206 can store executable-code components associated with the computation pipeline recommendation system 212, the computation pipeline module 214, the recommender module 216, and the communications stack 218 for execution by the processor 204. The memory 206 can also store data such as the data described below that can be stored in the data store 210, among other data. For instance, the memory 206 can also store at least one of the local data 122, 124, 126, 128, the context data 132, 134, 136, 138, the incomplete and/or completed recommendation matrix 140, the tree model (e.g., a linear regression tree model in some cases), or the treed extended matrix completion models.

The memory 206 can store other executable-code components (e.g., executable software) for execution by the processor 204. For example, an operating system can be stored in the memory 206 for execution by the processor 204. The computation pipeline recommendation system 212 is also another example of an executable-code component that can be executed by the processor 204. Where any component discussed herein is implemented in the form of executable software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages to implement the software.

As discussed above, the memory 206 can store software for execution by the processor 204. In this respect, the terms “executable” or “for execution” refer to software forms that can ultimately be run or executed by the processor 204, whether in source, object, machine, or other form. Examples of executable programs include, for instance, a compiled program that can be translated into a machine code format and loaded into a random access portion of the memory 206 and executed by the processor 204, source code that can be expressed in an object code format and loaded into a random access portion of the memory 206 and executed by the processor 204, source code that can be interpreted by another executable program to generate instructions in a random access portion of the memory 206 and executed by the processor 204, or other executable programs or code.

The local interface 208 can be embodied as a data bus with an accompanying address/control bus or other addressing, control, and/or command lines. As examples, the local interface 208 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 210 can include data for the computing device 202 such as, for instance, one or more unique identifiers for the computing device 202, digital certificates, encryption keys, session keys and session parameters for communications, and other data for reference and processing. The data store 210 can also store computer-readable instructions for execution by the computing device 202 via the processor 204, including instructions for the computation pipeline recommendation system 212, the computation pipeline module 214, the recommender module 216, and the communications stack 218. In some cases, the data store 210 can also store at least one of the local data 122, 124, 126, 128, the context data 132, 134, 136, 138, the incomplete and/or completed recommendation matrix 140, the tree model (e.g., a linear regression tree model in some cases), or the treed extended matrix completion models.

The computation pipeline recommendation system 212 can be embodied as one or more software applications or services executing on the computing device 202. For example, the computation pipeline recommendation system 212 can be embodied as and can include the computation pipeline module 214, the recommender module 216, and other executable modules or services. The computation pipeline recommendation system 212 can be executed by the processor 204 to implement at least one of the computation pipeline module 214 or the recommender module 216. Each of the computation pipeline module 214 and the recommender module 216 can also be respectively embodied as one or more software applications or services executing on the computing device 202. In one example, the computation pipeline recommendation system 212 can be executed by the processor 204 to generate the incomplete recommendation matrix 302, predict missing performance data in the incomplete recommendation matrix 302, and provide at least one of a ranking or a recommendation of one or more computation pipelines for use with a particular contextual dataset (or a range of contextual datasets) using the computation pipeline module 214 and the recommender module 216 as described herein.

The computation pipeline module 214 can be embodied as one or more software applications or services executing on the computing device 202. The computation pipeline module 214 can be executed by the processor 204 to generate different computation pipelines that are each indicative of and correspond to a unique AI model. Each computation pipeline, and thus each corresponding unique AI model, is defined as a unique sequence of different AI method options that can be implemented sequentially to perform different AI operations. For example, the computation pipeline module 214 can configure and/or operate with or on the computation pipelines associated with the incomplete and completed recommendation matrices described herein.

The recommender module 216 can be embodied as one or more software applications or services executing on the computing device 202. The recommender module 216 can be executed by the processor 204 to evaluate one or more computation pipelines with respect to contextual datasets and identify the relatively best computation pipelines for use with contextual datasets. For example, the recommender module 216 can evaluate different computation pipelines with respect to the different contexts of the contextual datasets described herein.

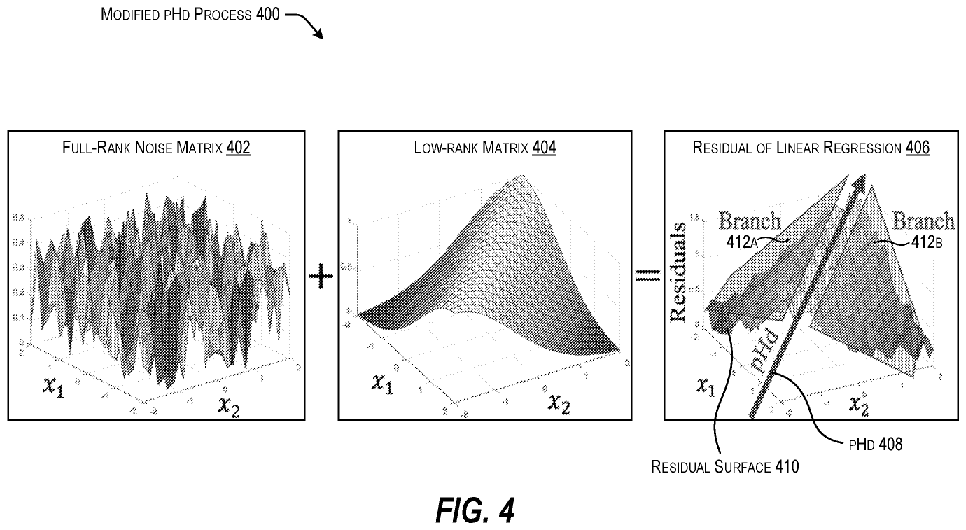

To perform such evaluation of computation pipelines with respect to at least one contextual dataset, the recommender module 216 can implement one or more aspects of the Lori framework of the present disclosure. For example, to perform such computation pipeline evaluations for computation pipelines included in an incomplete recommendation matrix (e.g., the incomplete recommendation matrix 140 or the incomplete recommendation matrix 302), the recommender module 216 can perform the matrix segmenting process 300a, the matrix segmenting process 300b, and the modified pHd process 400 described below with reference to FIGS. 3A, 3B, and 4, respectively. Based on performing such processes, the recommender module 216 can provide predicted values for any performance data that may be missing in the incomplete recommendation matrix.

The recommender module 216 and/or the computation pipeline recommendation system 212 can then use such predicted performance data values to create a completed recommendation matrix (e.g., the completed recommendation matrix 140). The completed recommendation matrix can therefore include empirical or predicted performance data for all computation pipelines with respect to all contextual datasets. The recommender module 216 can then use the completed recommendation matrix to provide at least one of a computation pipeline recommendation or a ranking of the computation pipelines with respect to at least one contextual dataset.

In some examples, the recommender module 216 can perform its operations using one or more of the methodologies, models, estimators, equations, and algorithms described in “APPENDIX A” of U.S. Provisional Patent Application No. 63/363,528, the entire contents of which is incorporated herein by reference. In one particular example, the recommender module 216 can perform its operations by implementing the methodology described in connection with the Extended Matrix Completion (EMC) Model (1) and Estimator, Equations (2) to (5), and Algorithm 1 set forth in Sections 1.1, 3.1, and 3.2, respectively, in “APPENDIX A.”

In some examples, one or more of the computation pipeline recommendation system 212, the computation pipeline module 214, and the recommender module 216 can perform their respective operations using one or more of the methodologies, models, estimators, equations, and algorithms described in “APPENDIX A” of U.S. Provisional Patent Application No. 63/363,528. In one particular example, the computation pipeline recommendation system 212, the computation pipeline module 214, and the recommender module 216 can perform their operations in conjunction and/or as a single unit by implementing the methodology described in connection with the Extended Matrix Completion (EMC) Model (1) and Estimator, Equations (2) to (5), and Algorithm 1 set forth in Sections 1.1, 3.1, and 3.2, respectively, in “APPENDIX A” of U.S. Provisional Patent Application No. 63/363,528.

The communications stack 218 can include software and hardware layers to implement wired or wireless data communications such as, for instance, Bluetooth®, BLE, WiFi®, cellular data communications interfaces, or a combination thereof. Thus, the communications stack 218 can be relied upon by each of the computing devices 110, 112, 114, 116, 118 to establish cellular, Bluetooth®, WiFi®, and other communications channels with the networks 120 and with one another.

The communications stack 218 can include the software and hardware to implement Bluetooth®, BLE, and related networking interfaces, which provide for a variety of different network configurations and flexible networking protocols for short-range, low-power wireless communications. The communications stack 218 can also include the software and hardware to implement WiFi® communication, and cellular communication, which also offers a variety of different network configurations and flexible networking protocols for mid-range, long-range, wireless, and cellular communications. The communications stack 218 can also incorporate the software and hardware to implement other communications interfaces, such as X10®, ZigBee®, Z-Wave®, and others. The communications stack 218 can be configured to communicate various data amongst the computing devices 110, 112, 114, 116, 118, such as the contextual datasets and the incomplete and completed recommendation matrices according to examples described herein.

The data collection devices 220 can be embodied as one or more of the above-described sensors, actuators, or instruments that can be included in or coupled (e.g., communicatively, operatively) to and respectively used by any of the entities 102, 104, 106, 108 to capture or measure their respective local data 122, 124, 126, 128. The data collection devices 220 can include at least one of sensors, actuators, or instruments that allow for the capture or measurement of various types of data associated with the respective operations, machines, instruments, equipment, processes, materials, recipes, products, services, and the like, of the entities 102, 104, 106, 108.

FIG. 3A illustrates an example matrix segmenting process 300a that can facilitate local low-rank matrix imputation for contextual computation pipeline recommendation according to at least one embodiment of the present disclosure. The matrix segmenting process 300a can be performed by any or all of the computing devices 110, 112, 114, 116, 118 using the computation pipeline recommendation system 212 as described above with reference to FIGS. 1 and 2. More specifically, the matrix segmenting process 300a can be performed by any or all of the computing devices 110, 112, 114, 116, 118 using the recommender module 216 to segment an incomplete recommendation matrix 302 into multiple local low-rank submatrices 308, 310, 312, 314.

FIG. 3A illustrates an incomplete recommendation matrix 302 and local low-rank submatrices 308, 310, 312, 314. The incomplete recommendation matrix 302 is similar to and can include the same attributes, structure, and functionality as that of the incomplete recommendation matrix 140 described above with reference to FIGS. 1 and 2. The local low-rank submatrices 308, 310, 312, 314 can include the same attributes, structure, and functionality as that of the local low-rank submatrices described above with reference to FIGS. 1 and 2.

As illustrated in FIG. 3A, the incomplete recommendation matrix 302 includes data associated with multiple contextual datasets 304 (denoted as “C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀” in FIG. 3A) and multiple computation pipelines 306 (denoted as “P₁, P₂, P₃, P₄, P₅, P₆, P₇, P₈, P₉, P₁₀” in FIG. 3A). The contextual datasets 304 can include the same attributes, structure, and functionality as that of the contextual datasets 132, 134, 136, 138, among others, described above and denoted in FIGS. 1 and 2 as “context data 132, 134, 136, 138”. The computation pipelines 306 can be associated with the same attributes, structure, and functionality as that of the computation pipelines described above with reference to FIGS. 1 and 2.

As illustrated in FIG. 3A, the incomplete recommendation matrix 302 includes performance data d_{m,n} (denoted as “d_{1,1}” to “d_{20,10}” in FIG. 3A) for the computation pipelines 306 with respect to the contextual datasets 304. The performance data d_{m,n} can include the same attributes, structure, and functionality as that of the performance data described above with reference to FIGS. 1 and 2. The cells in the incomplete recommendation matrix 302, which represent the performance data d_{m,n}, can correspond to different defined degrees of accuracy or performance. In this example, the darker colored cells represent a relatively more accurate degree of accuracy, and the lighter colored cells represent a relatively lower degree of accuracy. The cells ranging between the darkest and the lightest colored cells correspond to a range of accuracy between the relatively most accurate and the relatively least accurate degree of accuracy, respectively.

Additionally, the incomplete recommendation matrix 302 can lack performance data for some of the computation pipelines 306 with respect to some of the contextual datasets 304. Specifically, the incomplete recommendation matrix 302 lacks performance data for the computation pipelines 306 denoted as “P₂, P₃, P₄, P₆, P₇, P₉, P₁₀” in FIG. 3A with respect to the contextual datasets 304 denoted as “C₁₆, C₃, C₇, C₁₅, C₁₉, C₄, C₁₀”. The missing performance data is represented as empty elements e_{m,n} in the incomplete recommendation matrix 302, as well as the local low-rank submatrices 308, 310, 312, 314, and they are denoted as e_{16,2}, e_{3,3}, e_{7,4}, e_{15,6}, e_{19,7}, e_{4,9}, e_{10,10} in FIG. 3A.

Any of the computing devices 110, 112, 114, 116, 118 such as, for instance, the computing device 110 can perform the matrix segmenting process 300a by implementing the recommender module 216 to segment the incomplete recommendation matrix 302 into the local low-rank submatrices 308, 310, 312, 314. The recommender module 216 can segment the incomplete recommendation matrix 302 based on robust pHds of local low-rank properties of the incomplete recommendation matrix 302 and similarities between covariates of the computation pipelines 306 and the contextual datasets 304. In this way, the recommender module 216 can segment the incomplete recommendation matrix 302 such that subsets of the computation pipelines 306 having similar performance data d_{m,n} can be grouped together in the local low-rank submatrices 308, 310, 312, 314 as illustrated in FIG. 3A. Additionally, based on such segmentation, each of the local low-rank submatrices 308, 310, 312, 314 in this example can include one or more of the empty elements e_{m,n}.

In some cases, at this point in the matrix segmenting process 300a, the computing device 110 can further implement the recommender module 216 to predict the missing performance data for each of the empty elements e_{m,n} in each of the local low-rank submatrices 308, 310, 312, 314. For example, as described above with reference to FIGS. 1 and 2, the recommender module 216 can implement a different treed extended matrix completion model for each of the local low-rank submatrices 308, 310, 312, 314 to predict the missing performance data for each of the empty elements e_{m,n} of the local low-rank submatrices 308, 310, 312, 314. Each treed extended matrix completion model can predict such missing performance data based on the information learned when the recommender module 216 performed the matrix segmenting process 300a.

In other cases, at this point in the matrix segmenting process 300a, the computing device 110 can further implement the recommender module 216 to respectively segment one or more the local low-rank submatrices 308, 310, 312, 314 into additional local low-rank submatrices. For example, the computing device 110 can further implement the recommender module 216 to perform the matrix segmenting process 300b described below and illustrated in FIG. 3B to respectively segment the local low-rank submatrices 308, 312, 314 into local low-rank submatrices 308a, 308b, 312a, 312b, 314a, 314b.

FIG. 3B illustrates another example matrix segmenting process 300b that can facilitate local low-rank matrix imputation for contextual computation pipeline recommendation according to at least one embodiment of the present disclosure. The matrix segmenting process 300b can be a second segmenting iteration of a recursive matrix segmenting process that includes the matrix segmenting process 300a as a first segmenting iteration.

Although only two segmenting iterations are described herein and illustrated in FIGS. 3A and 3B (i.e., the matrix segmenting process 300a and the matrix segmenting process 300b, respectively), the Lori framework of the present disclosure is not so limited. In some cases, the recursive matrix segmenting process noted above can include additional segmenting iterations beyond the matrix segmenting process 300b. For example, in some cases, the computing device 110 can implement the recommender module 216 to recursively segment the incomplete recommendation matrix 302 until the recommender module 216 can no longer identify a local low-rank submatrix that can be segmented.

In the example depicted in FIG. 3B, the computing device 110 can implement the recommender module 216 to perform the matrix segmenting process 300b to respectively segment the local low-rank submatrices 308, 312, 314 into local low-rank submatrices 308a, 308b, 312a, 312b, 314a, 314b. In particular, the recommender module 216 can respectively segment the local low-rank submatrices 308, 312, 314 based on robust pHds of local low-rank properties of the incomplete recommendation matrix 302 and similarities between covariates of the computation pipelines 306 and the contextual datasets 304. In this way, the recommender module 216 can respectively segment the local low-rank submatrices 308, 312, 314 such that subsets of the computation pipelines 306 having similar performance data d_{m,n} can be grouped together in the local low-rank submatrices 308a, 308b, 312a, 312b, 314a, 314b as illustrated in FIG. 3B. Additionally, based on such segmenting, each of the local low-rank submatrices 308a, 308b, 312a, 312b, 314a, 314b in this example can include one of the empty elements e_{m,n}.

In some cases, at this point in the matrix segmenting process 300b, the computing device 110 can further implement the recommender module 216 to predict the missing performance data for each of the empty elements e_{m,n} in each of the local low-rank submatrices 308a, 308b, 312a, 312b, 314a, 314b. For example, as described above with reference to FIGS. 1 and 2, the recommender module 216 can implement a different treed extended matrix completion model for each of the local low-rank submatrices 308a, 308b, 312a, 312b, 314a, 314b to predict the missing performance data for each of the empty elements e_{m,n} of the local low-rank submatrices 308a, 308b, 312a, 312b, 314a, 314b. Each treed extended matrix completion model can predict such missing performance data based on the information learned when the recommender module 216 performed the matrix segmenting process 300a, the matrix segmenting process 300b, or both.

Once all treed extended matrix completion models have populated all the empty elements e_{m,n} in all of the local low-rank submatrices 308a, 308b, 312a, 312b, 314a, 314b with predicted performance data, the computing device 110 can thereby create a completed recommendation matrix 140. The completed recommendation matrix 140 can therefore include empirical or predicted performance data for all of the computation pipelines 306 with respect to all of the contextual datasets 304. Further, the computing device 110 can rank the computation pipelines 306, or a subset thereof, that are included in the completed recommendation matrix 140 with respect to any or all of the contextual datasets 304 based on their respective empirical or predicted performance data. In some cases, the computing device 110 can also generate a recommendation of one or more of the computation pipelines 306 in the completed recommendation matrix 140 that are relatively best suited for one or more of the contextual datasets 304 based on ranking the computation pipelines 306 with respect to the contextual datasets 304.

As illustrated in FIG. 3B, the level of performance for the computation pipelines 306 in each of the local low-rank submatrices 308a, 308b, 312a, 312b, 314a, 314b are relatively more similar to one another with respect to their corresponding contextual datasets 304 than the computation pipelines 306 in each of the local low-rank submatrices 308, 310, 312, 314. By recursively segmenting the incomplete recommendation matrix 302 into the local low-rank submatrices 308a, 308b, 312a, 312b, 314a, 314b, the computing device 110 (e.g., via the recommender module 216) can more accurately predict the missing performance data for the empty elements e_{m,n} in the local low-rank submatrices 308a, 308b, 312a, 312b, 314a, 314b. Specifically, the computing device 110 can more accurately predict such missing performance data because such predictions are based on relatively more accurate representations of the similarities and dissimilarities across the computation pipelines 306 with respect to the contextual datasets 304. In this way, the computing device 110 can provide a computation pipeline recommendation and/or ranking that is relatively more accurate because it is based on such relatively more accurate representations of the similarities and dissimilarities across the computation pipelines 306 with respect to the contextual datasets 304.

FIG. 4 illustrates a representation of an example modified principal Hessian directions (pHd) process 400 that can facilitate local low-rank matrix imputation for contextual computation pipeline recommendation according to at least one embodiment of the present disclosure. The modified pHd process 400 can correspond to and represent the robust pHd process described above with reference to FIGS. 1 and 2. In particular, the modified pHd process 400 can be performed to estimate the robust pHds that can be used to segment an incomplete recommendation matrix into multiple local low-rank submatrices according to examples described herein.

The modified pHd process 400 can be performed by any or all of the computing devices 110, 112, 114, 116, 118 using the computation pipeline recommendation system 212 as described above with reference to FIGS. 1 and 2. More specifically, the modified pHd process 400 can be performed by any or all of the computing devices 110, 112, 114, 116, 118 using the recommender module 216 to combine a full-rank noise matrix 402 with a low-rank matrix 404 to create a residual of linear regression 406. Based on such a combination of the full-rank noise matrix 402 with the low-rank matrix 404, the recommender module 216 can estimate a pHd 408 along a residual surface 410 of a linear regression representation of the residual of linear regression 406. The pHd 408 can include the same attributes, structure, and functionality as that of the robust pHds described above with reference to FIGS. 1 and 2. The “x₁” and “x₂” terms depicted in FIG. 4 represent covariates of computation pipelines and contextual datasets.

In the example depicted in FIG. 4, the residual of linear regression 406 can include or be indicative of a linear regression representation defined by a residual matrix. The linear regression representation can include the residual surface 410 that is also defined by the residual matrix. The residual surface 410 can include a curvature (i.e., a ridge) that can be identified by the recommender module 216 when performing the modified pHd process 400. In particular, the curvature of the residual surface 410 can be indicative of and/or define the pHd 408, which can also be identified or estimated by the recommender module 216 when performing the modified pHd process 400. Based on identifying or estimating the pHd 408, the recommender module 216 can then implement a tree model described herein to split the residual surface 410 along the pHd 408 to create branches 412a, 412b, which can be approximated by a hyperplane (i.e., a linear regressor) defined on a dimensional space expanded on covariates (x₁, x₂) of computation pipelines and contextual datasets.

By implementing the modified pHd process 400, the recommender module 216 can use the full-rank noise matrix 402 to reduce the impact of Gaussian noise such that neither the modified pHd process 400 nor the pHd 408 are affected by such noise, to the extent possible. Additionally, when implementing the modified pHd process 400, the recommender module 216 can provide an estimated performance value or values for performance data missing in the low-rank matrix 404. In this way, the modified pHd process 400 can be implemented such that neither the modified pHd process 400 nor the pHd 408 are affected by such missing performance data.

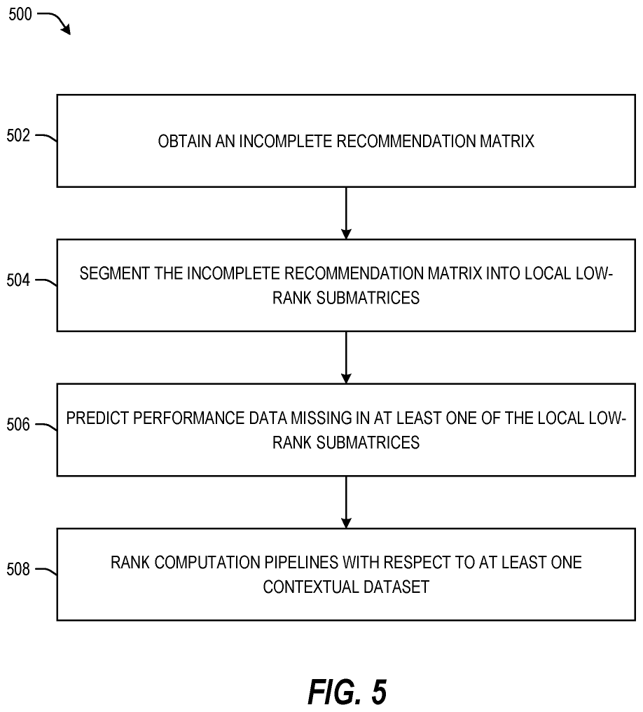

FIG. 5 illustrates a flow diagram of an example computer-implemented method 500 that can facilitate local low-rank matrix imputation for contextual computation pipeline recommendation according to at least one embodiment of the present disclosure. In one example, computer-implemented method 500 (hereinafter, “the method 500”) can be implemented by the computing device 110 (e.g., the computing device 202). In another example, the method 500 can be implemented by any of the entities 102, 104, 106, 108 using, for instance, their respective computing device 112, 114, 116, 118 (e.g., the computing device 202). The method 500 can be implemented in the context of at least one of the environment 100, the computing environment 200, or another environment using one or more of the matrix segmenting process 300a, the matrix segmenting process 300b, or the modified pHd process 400.

At 502, method 500 can include obtaining an incomplete recommendation matrix. For example, the computing device 110 can implement the recommender module 216 of the computation pipeline recommendation system 212 to generate the incomplete recommendation matrix 140. The incomplete recommendation matrix 302 can include the performance data d_{m,n} for the computation pipelines 306 with respect to the contextual datasets 304. The incomplete recommendation matrix 302 can also lack performance data for some of the computation pipelines 306 with respect to some of the contextual datasets 304. Specifically, the incomplete recommendation matrix 302 can lack performance data for the computation pipelines 306 denoted as “P₂, P₃, P₄, P₆, P₇, P₉, P₁₀” in FIG. 3A with respect to the contextual datasets 304 denoted as “C₁₆, C₃, C₇, C₁₅, C₁₉, C₄, C₁₀” in FIG. 3A, respectively.

At 504, method 500 can include segmenting the incomplete recommendation matrix into local low-rank submatrices. For example, the computing device 110 can implement the recommender module 216 to segment the incomplete recommendation matrix 302 into the local low-rank submatrices 308, 310, 312, 314 by performing the matrix segmenting process 300a. In some cases, the computing device 110 can further implement the recommender module 216 to segment the local low-rank submatrices 308, 310, 312, 314 into the local low-rank submatrices 308a, 308b, 312a, 312b, 314a, 314b by performing the matrix segmenting process 300b. Based on performing at least one of the matrix segmenting process 300a or the matrix segmenting process 300, the local low-rank submatrices 308, 310, 312, 314 and the local low-rank submatrices 308a, 308b, 312a, 312b, 314a, 314b, respectively, can each lack performance data for one or more of the computation pipelines 306 with respect to one or more of the contextual datasets 304.

At 506, method 500 can include predicting performance data missing in at least one of the local low-rank submatrices. For example, the computing device 110 can implement the recommender module 216 to predict the missing performance data for each of the empty elements e_{m,n} in each of the local low-rank submatrices 308a, 308b, 312a, 312b, 314a, 314b. For instance, as described above with reference to FIGS. 1, 2, and 3B, the recommender module 216 can implement a different treed extended matrix completion model for each of the local low-rank submatrices 308a, 308b, 312a, 312b, 314a, 314b to predict the missing performance data for each of the empty elements e_{m,n} of the local low-rank submatrices 308a, 308b, 312a, 312b, 314a, 314b. Each treed extended matrix completion model can predict such missing performance data based on the information learned when the recommender module 216 performs the matrix segmenting process 300a and the matrix segmenting process 300b.

Once all treed extended matrix completion models have populated all the empty elements e_{m,n} in all of the local low-rank submatrices 308a, 308b, 312a, 312b, 314a, 314b with predicted performance data, the computing device 110 can thereby create a completed recommendation matrix 140. The completed recommendation matrix 140 can therefore include empirical or predicted performance data for all of the computation pipelines 306 with respect to all of the contextual datasets 304.

At 508, method 500 can include ranking computation pipelines with respect to at least one contextual dataset. For example, as described above with reference to FIG. 3B, once all treed extended matrix completion models have populated all the empty elements e_{m,n} in all of the local low-rank submatrices 308a, 308b, 312a, 312b, 314a, 314b with predicted performance data, the computing device 110 can thereby create a completed recommendation matrix 140. The computing device 110 can then rank the computation pipelines 306, or a subset thereof, that are included in the completed recommendation matrix 140 with respect to any or all of the contextual datasets 304 based on their respective empirical or predicted performance data. In some cases, the computing device 110 can also generate a recommendation of one or more of the computation pipelines 306 in the completed recommendation matrix 140 that are relatively best suited for one or more of the contextual datasets 304 based on ranking the computation pipelines 306 with respect to the contextual datasets 304.

Referring now to FIG. 2, an executable program can be stored in any portion or component of the memory 206. The memory 206 can be embodied as, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 206 can include both volatile and nonvolatile memory and data storage components. Volatile components are those that do not retain data values upon loss of power. Nonvolatile components are those that retain data upon a loss of power. Thus, the memory 206 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory devices.

As discussed above, the computation pipeline recommendation system 212, the computation pipeline module 214, the recommender module 216, and the communications stack 218 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIG. 5, the flowchart or process diagram shown in FIG. 5 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 204. The machine code can be converted from the source code. Further, each block can represent, or be connected with, a circuit or a number of interconnected circuits to implement a certain logical function or process step.

Although the flowchart or process diagram shown in FIG. 5 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the computation pipeline recommendation system 212, the computation pipeline module 214, the recommender module 216, and the communications stack 218 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 5. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method to recommend contextual computation pipelines, comprising:
obtaining, by a computing device, an incomplete recommendation matrix comprising first performance data for different computation pipelines with respect to different contextual datasets, the incomplete recommendation matrix lacking second performance data for a defined computation pipeline with respect to a defined contextual dataset;
segmenting, by the computing device, the incomplete recommendation matrix into local low-rank submatrices that lack the second performance data;
predicting, by the computing device, the second performance data for at least one of the local low-rank submatrices to create a completed recommendation matrix comprising the first performance data and the second performance data; and
ranking, by the computing device, at least one of the defined computation pipeline or one or more of the different computation pipelines with respect to at least one of the defined contextual dataset or one or more of the different contextual datasets based on the completed recommendation matrix.

2. The method to recommend contextual computation pipelines of claim 1, wherein segmenting the incomplete recommendation matrix comprises:
segmenting, by the computing device, the incomplete recommendation matrix based on one or more local low-rank properties of the incomplete recommendation matrix and one or more similarities between covariates of the different contextual datasets, the different computation pipelines, the defined contextual dataset, and the defined computation pipeline.

3. The method to recommend contextual computation pipelines of claim 1, wherein segmenting the incomplete recommendation matrix comprises:
performing, by the computing device, a modified principal Hessian directions process to estimate one or more principal Hessian directions of local low-rank properties of the incomplete recommendation matrix and covariates of the different contextual datasets, the different computation pipelines, the defined contextual dataset, and the defined computation pipeline,
wherein the modified principal Hessian directions process and the one or more principal Hessian directions are unaffected by Gaussian noise and unaffected by the second performance data lacking in the incomplete recommendation matrix and lacking in one or more of the local low-rank submatrices.

4. The method to recommend contextual computation pipelines of claim 3, wherein segmenting the incomplete recommendation matrix further comprises:
implementing, by the computing device, a tree model in an expanded effective dimension reduction space to segment the incomplete recommendation matrix along the one or more principal Hessian directions.

5. The method to recommend contextual computation pipelines of claim 1, wherein segmenting the incomplete recommendation matrix comprises:
segmenting, by the computing device, a residual surface of a linear regression representation that is defined in an expanded effective dimension reduction space based on the first performance data and covariates of the different contextual datasets, the different computation pipelines, the defined contextual dataset, and the defined computation pipeline,
wherein the residual surface is segmented along one or more principal Hessian directions that are unaffected by Gaussian noise and unaffected by the second performance data lacking in the incomplete recommendation matrix and lacking in one or more of the local low-rank submatrices.

6. The method to recommend contextual computation pipelines of claim 1, wherein segmenting the incomplete recommendation matrix comprises:
implementing, by the computing device, a tree model to recursively segment the incomplete recommendation matrix by growing one or more treed extended matrix completion models in an expanded effective dimension reduction space based on the first performance data and covariates of the different contextual datasets, the different computation pipelines, the defined contextual dataset, and the defined computation pipeline.

7. The method to recommend contextual computation pipelines of claim 1, wherein predicting the second performance data for at least one of the local low-rank submatrices comprises:
learning, by the computing device, one or more relationships between the first performance data and covariates of the different contextual datasets and the different computation pipelines based on segmenting the incomplete recommendation matrix; and
predicting, by the computing device, the second performance data for at least one of the local low-rank submatrices based on the one or more relationships.

8. The method to recommend contextual computation pipelines of claim 1, wherein predicting the second performance data for at least one of the local low-rank submatrices comprises:
learning, by the computing device, one or more similarities between first covariates of at least one of the different contextual datasets and at least one of the different computation pipelines and second covariates of the defined contextual dataset and the defined computation pipeline based on segmenting the incomplete recommendation matrix; and
predicting, by the computing device, the second performance data for at least one of the local low-rank submatrices based on the one or more similarities.

9. The method to recommend contextual computation pipelines of claim 1, wherein predicting the second performance data for at least one of the local low-rank submatrices comprises:
predicting, by the computing device, the second performance data based on one or more similarities between first covariates of at least one of the different contextual datasets and at least one of the different computation pipelines and second covariates of the defined contextual dataset and the defined computation pipeline.

10. The method to recommend contextual computation pipelines of claim 1, wherein predicting the second performance data for at least one of the local low-rank submatrices comprises:
training, by the computing device, one or more treed extended matrix completion models to predict the second performance data based on segmenting the incomplete recommendation matrix; and
implementing, by the computing device, the one or more treed extended matrix completion models to predict the second performance data for at least one of the local low-rank submatrices.

11. A computing device, comprising:
a memory device to store computer-readable instructions thereon; and
at least one processing device configured through execution of the computer-readable instructions to:
obtain an incomplete recommendation matrix comprising first performance data for different computation pipelines with respect to different contextual datasets, the incomplete recommendation matrix lacking second performance data for a defined computation pipeline with respect to a defined contextual dataset;
segment the incomplete recommendation matrix into local low-rank submatrices that lack the second performance data;
predict the second performance data for at least one of the local low-rank submatrices to create a completed recommendation matrix comprising the first performance data and the second performance data; and
rank at least one of the defined computation pipeline or one or more of the different computation pipelines with respect to at least one of the defined contextual dataset or one or more of the different contextual datasets based on the completed recommendation matrix.

12. The computing device of claim 11, wherein, to segment the incomplete recommendation matrix, the at least one processing device is further configured to:
segment the incomplete recommendation matrix based on one or more local low-rank properties of the incomplete recommendation matrix and one or more similarities between covariates of the different contextual datasets, the different computation pipelines, the defined contextual dataset, and the defined computation pipeline.

13. The computing device of claim 11, wherein, to segment the incomplete recommendation matrix, the at least one processing device is further configured to:
perform a modified principal Hessian directions process to estimate one or more principal Hessian directions of local low-rank properties of the incomplete recommendation matrix and covariates of the different contextual datasets, the different computation pipelines, the defined contextual dataset, and the defined computation pipeline,
wherein the modified principal Hessian directions process and the one or more principal Hessian directions are unaffected by Gaussian noise and unaffected by the second performance data lacking in the incomplete recommendation matrix and lacking in one or more of the local low-rank submatrices.

14. The computing device of claim 13, wherein, to segment the incomplete recommendation matrix, the at least one processing device is further configured to:
implement a tree model in an expanded effective dimension reduction space to segment the incomplete recommendation matrix along the one or more principal Hessian directions.

15. The computing device of claim 11, wherein, to segment the incomplete recommendation matrix, the at least one processing device is further configured to:
segment a residual surface of a linear regression representation that is defined in an expanded effective dimension reduction space based on the first performance data and covariates of the different contextual datasets, the different computation pipelines, the defined contextual dataset, and the defined computation pipeline,
wherein the residual surface is segmented along one or more principal Hessian directions that are unaffected by Gaussian noise and unaffected by the second performance data lacking in the incomplete recommendation matrix and lacking in one or more of the local low-rank submatrices.

16. The computing device of claim 11, wherein, to segment the incomplete recommendation matrix, the at least one processing device is further configured to:
implement a tree model to recursively segment the incomplete recommendation matrix by growing one or more treed extended matrix completion models in an expanded effective dimension reduction space based on the first performance data and covariates of the different contextual datasets, the different computation pipelines, the defined contextual dataset, and the defined computation pipeline.

17. The computing device of claim 11, wherein, to predict the second performance data for at least one of the local low-rank submatrices, the at least one processing device is further configured to:
learn one or more relationships between the first performance data and covariates of the different contextual datasets and the different computation pipelines based on segmenting the incomplete recommendation matrix; and
predict the second performance data for at least one of the local low-rank submatrices based on the one or more relationships.

18. A non-transitory computer-readable medium embodying at least one program that, when executed by at least one computing device, directs the at least one computing device to:
obtain an incomplete recommendation matrix comprising first performance data for different computation pipelines with respect to different contextual datasets, the incomplete recommendation matrix lacking second performance data for a defined computation pipeline with respect to a defined contextual dataset;
segment the incomplete recommendation matrix into local low-rank submatrices that lack the second performance data;
predict the second performance data for at least one of the local low-rank submatrices to create a completed recommendation matrix comprising the first performance data and the second performance data; and
rank at least one of the defined computation pipeline or one or more of the different computation pipelines with respect to at least one of the defined contextual dataset or one or more of the different contextual datasets based on the completed recommendation matrix.

19. The non-transitory computer-readable medium according to claim 18, wherein, to segment the incomplete recommendation matrix, the at least one computing device is further directed to:
segment the incomplete recommendation matrix based on one or more local low-rank properties of the incomplete recommendation matrix and one or more similarities between covariates of the different contextual datasets, the different computation pipelines, the defined contextual dataset, and the defined computation pipeline.

20. The non-transitory computer-readable medium according to claim 18, wherein, to segment the incomplete recommendation matrix, the at least one computing device is further directed to:
perform a modified principal Hessian directions process to estimate one or more principal Hessian directions of local low-rank properties of the incomplete recommendation matrix and covariates of the different contextual datasets, the different computation pipelines, the defined contextual dataset, and the defined computation pipeline,
wherein the modified principal Hessian directions process and the one or more principal Hessian directions are unaffected by Gaussian noise and unaffected by the second performance data lacking in the incomplete recommendation matrix and lacking in one or more of the local low-rank submatrices.
